(19) United States
(12) Patent Application Publication
(10) Pub. No.: US 2010/0096276 A1
(43) Pub. Date: Apr. 22, 2010

(54) MULTICOMPONENT ANALYSIS SENSOR AND METHOD OF MEASURING MULTIPLE COMPONENTS

(75) Inventors: Shinki Kojima, Kanagawa (JP); Tomohiro Yamamoto, Osaka (JP); Fumihisa Kitawaki, Kanagawa (JP); Tetsuo Yukimasa, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/444,077

(22) PCT Filed: Oct. 1, 2007
(86) PCT No.: PCT/JP2007/069217

§ 371 Date: Apr. 2, 2009

(30) Foreign Application Priority Data
Oct. 5, 2006 (JP) 2006-273832

(51) Int. Cl. G01N 27/26

(52) U.S. Cl. 205/777.5; 204/403.14

(57) ABSTRACT

A multicomponent analysis sensor for measuring two or more kinds of the subjects to be measured by using redox reactions, which is a multicomponent analysis sensor comprising a liquid sample inlet from which a liquid sample containing two or more kinds of the subjects to be measured is introduced, a first measurement chamber, a second measurement chamber, a first channel connecting the above-described liquid sample inlet to the above-described first measurement chamber and a second channel connecting the above-described first measurement chamber to the second measurement chamber, wherein the above-described first measurement chamber and the above-described second measurement chamber respectively have a working electrode and a counter electrode. A first reagent layer containing an enzyme and an electron transfer substance is provided in the first channel or the first chamber, while another reagent layer containing an enzyme is provided in the second channel or the second chamber.

### TECHNICAL FIELD

The present invention relates to a sensor for analyzing multiple components contained in a liquid sample, and a method of measuring multiple components contained in a liquid sample.

### BACKGROUND ART

Generally, conventional measurement instruments used in the clinical laboratory field include large-scale automatic analyzers and point-of-care testing (POCT) instruments.

Large-scale automatic analyzers are placed in the central clinical laboratory departments of hospitals or in companies mainly dealing with the trustee business of clinical research. With the large-scale automatic analyzer, samples from a large number of patients can be tested for multiple components (refer to Patent Document 1).

For example, 7170 type large-scale automatic analyzer manufactured by Hitachi Co., Ltd. can complete eight hundred tests per hour for up to thirty-six items. Therefore, such a large-scale automatic analyzer greatly contributes to higher test efficiency and is suitable in hospitals dealing with many test subjects.

However, large-scale automatic analyzers have so complicated structure that it is difficult for those who do not have a specialized knowledge to operate. Moreover, the large-scale automatic analyzers have the disadvantage of longer measurement times, increasing the time required for feeding back results to the test subject.

On the other hand, POCT instruments are used for clinical tests performed in the test rooms of hospitals or in medical scenes. The POCT instrument includes an enzyme sensor using an enzyme reaction, as represented by a blood sugar sensor, and a qualitative immunity sensor using an antigen-antibody reaction, as represented by a pregnancy diagnosis sensor.

These POCT instruments are less versatile than large-scale automatic analyzers, but can easily and rapidly obtain a measurement result for a specific type of illness. Therefore, the POCT instruments are effective in screening and monitoring test subjects. The POCT instruments are also small in size and thus have excellent portability; therefore, they can be introduced at low costs. In addition, the POCT instrument does not require special expertise and anybody can use it easily. Also, POCT instruments intended for multicomponent analysis have been developed and becoming widely used not only in the therapeutic medicine field, but also in the preventive medicine field.

Conventionally, a multicomponent analysis sensor having a plurality of measurement chambers in each of which a reaction material having a reagent according to each measurement item is disposed is known (refer to Patent Document 2). Such a multicomponent analysis sensor is described below with reference to the drawing.

FIG. 1 is a plan view of multicomponent analysis sensor 1 having a plurality of measurement chambers in each of which a reaction material having a reagent according to each measurement item is disposed.

Referring to FIG. 1, multicomponent analysis sensor 1 includes liquid sample inlet 11, channel 12, reaction materials 13 each having a corresponding reagent in order to measure an analyte, and measurement chambers 14 each allowing a reaction material and an analyte to react with each other, and detecting a chemical change.

When a liquid sample containing an analyte is injected from liquid sample inlet 11, the liquid sample flows through channel 12 and is transported up to respective measurement chambers 14. Then, reaction materials 13 disposed in the respective measurement chambers and the analyte contained in the liquid sample react with each other, and thus a material in the liquid sample changes. It is possible to measure multiple components using a single sensor by optically detecting this change.

There is also an analysis sensor for analyzing two components without transporting a liquid sample to separate measurement chambers (refer to Patent Document 3). A multi component analysis sensor described in Patent Document 3 measures an analyte in a liquid sample while the sensor is immersed in the liquid sample in a beaker and the liquid sample in the beaker is stirred. Such a multicomponent analysis sensor is described with reference to the drawing.

FIG. 2 is a cross-sectional view of multicomponent analysis sensor 2. Referring to FIG. 2, multicomponent analysis sensor 2 includes inner tube 21, outer tube 22, first electrode 23 disposed in the bottom portion of the inner tube, inner liquid 24, second electrode 25 disposed in the inner liquid, first immobilized enzyme 26 and second immobilized enzyme 27 disposed close to first electrode 23, intermediate membrane 28 disposed between first immobilized enzyme 26 and second immobilized enzyme 27, oxygen gas permeable membrane 29, and dialysis membrane 30.

First, sensor 2 is immersed in a solution in a beaker, a predetermined voltage is applied between first electrode 23 and second electrode 25 of sensor 2, and then a current value is measured. When the current value reaches a plateau, the liquid sample is poured into the beaker. Then, first immobilized enzyme 26 and a first analyte react with each other, and the current value reduces and reaches a plateau. After that, the liquid sample diffuses through intermediate membrane 28. Then, a second analyte and second immobilized enzyme 27 react with each other, and the current value reduces. The amount of the analyte can be measured from a current value changed by these reactions.

While oxygen is used as an electron acceptor in the sensor of Patent Document 3, there is also a sensor in which a metal complex or an organic compound is used as an electron acceptor. This type of sensor has the advantage of being able to make measurements even under a condition where oxygen is absent, because the sensor is less likely to be influenced by dissolved oxygen concentration.

For example, there is a cholesterol sensor using potassium ferricyanide as an electron acceptor (refer to Patent Document 4). In the cholesterol sensor of Patent Document 4, an electrode pair of a measurement electrode and a counter electrode is formed on an insulating substrate using a method such as screen printing. A reaction reagent layer containing an electron acceptor such as cholesterol oxidase and potassium ferricyanide is further formed on the electrode pair. In the cholesterol sensor of Patent Document 4, potassium ferricyanide is used as an electron acceptor, and cholesterol contained in a liquid sample is oxidized, thereby reducing a ferricyanide ion. When reduced, a ferricyanide ion changes into a ferrocyanide ion. The amount of cholesterol can be measured by measuring the amount of ferrocyanide ions using the electrodes.
Patent Document 1: Japanese Patent Application Laid-Open No. 9-127126
Patent Document 2: Japanese Patent Application Laid-Open No. 2006-52950
Patent Document 3: Japanese Patent Application Laid-Open No. 60-147644
Patent Document 4: Japanese Patent Application Laid-Open No. 10-232219

### DISCLOSURE OF INVENTION

### Problems to be Solved by the Invention

However, since the multicomponent analysis sensor of Patent Document 2 has to allow a liquid sample to branch to respective measurement chambers, a large amount of liquid sample is required. Accordingly, it is difficult to measure multiple components from a very small amount of liquid sample.

Also, in the multicomponent analysis sensor of Patent Document 3, the structure of the sensor becomes complicated in the case of performing measurement for three items or more. In addition, there is a disadvantage that measurement errors occur at the time when an immobilized enzyme diffuses in a solution. Further, the solution should be stirred in order to make a difference in diffusion rate.

In addition, to measure multiple components using an electron acceptor, a separate electron acceptor is required for each measurement component.

It is an object of the present invention to provide a multicomponent analysis sensor that can accurately measure multiple components in a liquid sample using a very small amount of liquid sample.

### Means for Solving the Problems

According to an aspect of the present invention, there is provided a multicomponent analysis sensor described below:

[1] A multicomponent analysis sensor for measuring two or more analytes using a redox reaction, including a liquid sample inlet through which a liquid sample containing two or more analytes is introduced, a first measurement chamber, a second measurement chamber, a first channel which connects the liquid sample inlet with the first measurement chamber, and a second channel which connects the first measurement chamber with the second measurement chamber, in which each of the first measurement chamber and the second measurement chamber includes a working electrode and a counter electrode,

[2] A multicomponent analysis sensor for measuring two or more analytes using a redox reaction, including a liquid sample inlet through which a liquid sample containing two or more analytes is introduced, a first measurement chamber, a second measurement chamber, a first channel which connects the liquid sample inlet with the first measurement chamber, and a second channel which connects the first measurement chamber with the second measurement chamber, in which each of the first measurement chamber, the second channel and the second measurement chamber includes a working electrode and a counter electrode.

[3] A multicomponent analysis sensor for measuring two or more analytes using a redox reaction, including a liquid sample inlet through which a liquid sample containing two or more analytes is introduced, a first measurement chamber, an intermediate chamber, a second measurement chamber, a first channel which connects the liquid sample inlet with the first measurement chamber, a second channel connecting the first measurement chamber with the intermediate chamber, and a third channel which connects the intermediate chamber with the second measurement chamber, in which each of the first measurement chamber, the intermediate chamber, and the second measurement chamber includes a working electrode and a counter electrode.

[4] A multicomponent analysis sensor according to any one of [1] to [3] further including a first enzyme and an electron transport material disposed in one of the first channel and the first measurement chamber, and a second enzyme disposed in one of the second channel, the third channel, and the second measurement chamber.

[5] A multicomponent analysis sensor according to [4], in which one of the working electrode and the counter electrode provided in the first measurement chamber, one of the working electrode and the counter electrode provided in the second channel, or one of the working electrode and the counter electrode provided in the intermediate chamber is covered with a polymer.

[6] A multicomponent analysis sensor according to any one of [1] to [5], in which one of the working electrode and the counter electrode provided in the first measurement chamber, one of the working electrode and the counter electrode provided in the second channel, or one of the working electrode and the counter electrode provided in the intermediate chamber is a porous material.

According to another aspect of the present invention, there is provided a method of measuring multiple components described below:

[7] A method of measuring two or more analytes in one liquid sample, using an analysis apparatus including the multicomponent analysis sensor according to any one of [4] to [6], an installation section on which the sensor is mounted, a transport section that transports a liquid sample to a measurement chamber provided in the sensor, an applying section that applies a potential to an electrode system of the sensor, an instrument section that measures a current flowing through the electrode system of the sensor, and a control section that controls the transport section, the applying section, and the instrument section, including A) supplying the liquid sample to the liquid sample inlet, B) transporting the liquid sample to the first measurement chamber by the transport section, C) oxidizing or reducing the electron transport material by allowing a first analyte in the liquid sample, the first enzyme, and the electron transport material to react one another, D) applying a potential by the applying section to the working electrode and the counter electrode of the first measurement chamber to which the liquid sample has been transported, E) measuring the first analyte by measuring, at the instrument section, a current flowing between the working electrode and the counter electrode of the first measurement chamber, F) changing the electron transport material oxidized or reduced in C) into a reductant or an oxidant reactable with a second analyte in the liquid sample, G) transporting the liquid sample to the second measurement chamber by the transport section, H) allowing the second analyte, the second enzyme, and the changed electron transport material to react with one another to oxidize or reduce the electron transport material, I) applying a potential by the applying section to the working electrode and the counter electrode of the second measurement chamber to which the liquid sample has been transported, and J) measuring the second analyte by measuring, at the instrument section, a current flowing between the working electrode and the counter electrode of the second measurement chamber.

[8] A method of measuring two or more analytes in one liquid sample, according to [7], in which a current is measured at the instrument section in F), the current value measured at the instrument section is corrected using the measured current value in J), and the second analyte is measured based on the corrected current value.

### Advantageous Effects of the Invention

In a multicomponent analysis sensor and a method of measuring multiple components according to an embodiment of the present invention, a liquid sample that has been used for measuring one analyte can be utilized for measuring another additional analyte. Therefore, a plurality of analytes can be measured using a very small amount of liquid sample.

In addition, since an electron transport material that has been changed by reaction with one analyte is changed into a reductant or an oxidant that can efficiently react with another analyte and utilized again, multiple analytes can be measured accurately.

Further, since an electron transport material that has been changed by reaction with one analyte is utilized for reaction with another analyte, multiple components can be measured using a small amount of reagent. Therefore, reagent costs can be reduced, and an inexpensive multicomponent analysis sensor can be provided.

### BRIEF DESCRIPTION OF DRAWINGS

FIG. 1 is a plan view of a conventional multicomponent analysis sensor.

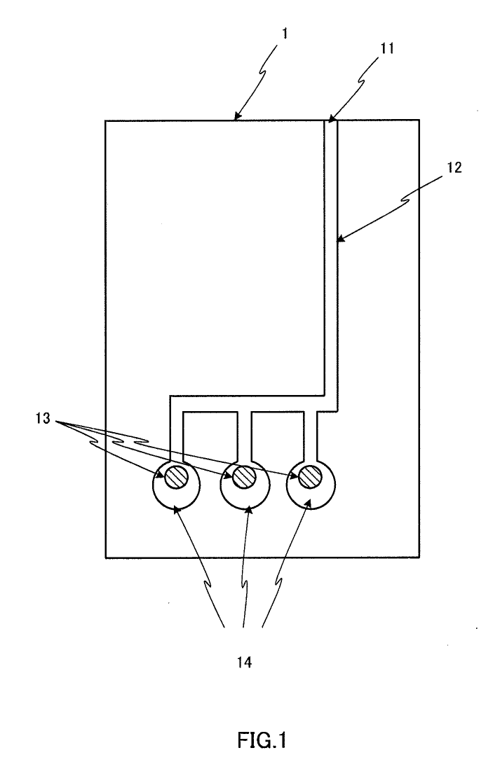

FIG. 2 is a cross-sectional view of another multicomponent analysis sensor according to a related art.

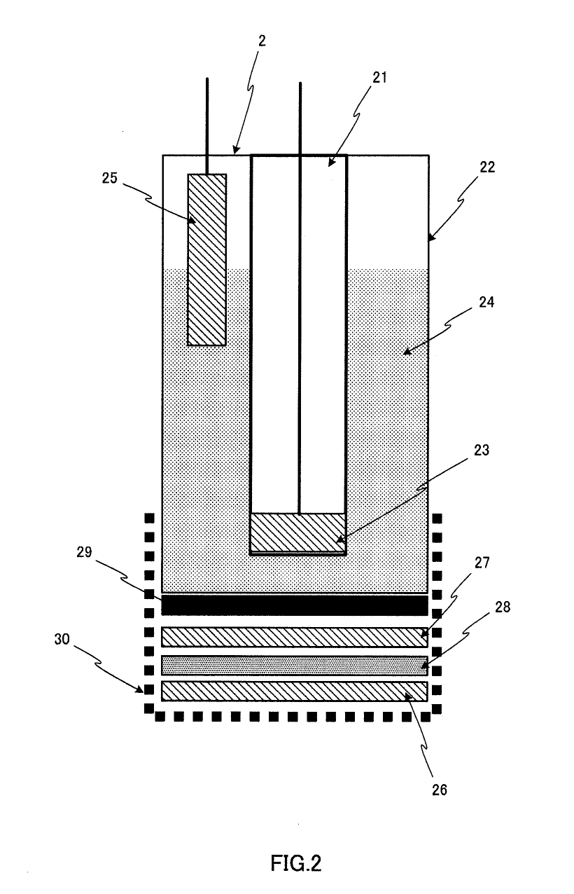

FIG. 3 is an exploded perspective view of a multicomponent analysis sensor according to Embodiment 1 of the present invention.

FIGS. 4A and 4B area plan view and a cross-sectional view of the multicomponent analysis sensor according to Embodiment 1 of the present invention, respectively.

FIG. 5 is a flowchart illustrating a method of measuring multiple components using the multicomponent analysis sensor according to Embodiment 1 of the present invention.

FIG. 6 is a plan view of a multicomponent analysis sensor according to Embodiment 2 of the present invention.

FIG. 7 is a flowchart illustrating a method of measuring multiple components using the multicomponent analysis sensor according to Embodiment 2 of the present invention.

FIG. 8 is a plan view of a multicomponent analysis sensor according to Embodiment 3 of the present invention.

FIG. 9 is a flowchart illustrating a method of measuring multiple components using the multicomponent analysis sensor according to Embodiment 3 of the present invention.

FIG. 10 is a plan view of a multicomponent analysis sensor according to Embodiment 4 of the present invention.

FIG. 11 is a plan view of a multicomponent analysis sensor according to Embodiment 5 of the present invention.

FIG. 12 is a plan view of a multicomponent analysis sensor according to Embodiment 6 of the present invention.

FIG. 13 is a flowchart illustrating a method of measuring multiple components using a multicomponent analysis sensor according to Embodiment 6 of the present invention.

FIG. 14 is a perspective view of an analysis apparatus according to the present invention.

FIG. 15 is a block diagram illustrating the construction of the analysis apparatus according to the present invention.

### BEST MODE FOR CARRYING OUT THE INVENTION

1. Regarding a Multicomponent Analysis Sensor According to the Present Invention

A multicomponent analysis sensor according to an embodiment of the present invention includes a liquid sample inlet, a first measurement chamber, a first reagent layer, a second measurement chamber, a second reagent layer, and a channel connecting the first measurement chamber with the second measurement chamber.

The liquid sample inlet is an opening through which a liquid sample is introduced. The shape and size of the liquid sample inlet are not particularly limited as far as the liquid sample is smoothly introduced.

The liquid sample is not particularly limited as far as the liquid sample contains two or more analytes. Examples of the liquid sample include body fluids such as blood, serum, blood plasma, urine, and supernatant of culture medium.

“Analyte” refers to a substance to be measured using a multicomponent analysis sensor according the present invention. Examples of the analyte include glucose, fructosylamine, lactic acid, uric acid, acetic acid, cholesterol, alcohol, glutamic acid, pyruvic acid, and sarcosine. Here, “measurement” means either detection of an analyte in a liquid sample or measurement of the amount of an analyte in a liquid sample by measuring a current value by an electron transport material oxidized or reduced by a redox reaction with the analyte, which will be described later.

The first measurement chamber is a chamber for measuring a first analyte contained in the liquid sample. The first measurement chamber has an electrode pair of a working electrode and a counter electrode in order to measure the analyte, and may also have a third electrode, for example, a reference electrode. The liquid sample inlet communicates at least with the first measurement chamber, and may be formed to directly communicate with the first measurement chamber, or may communicate with the first measurement chamber via a channel.

The first reagent layer contains a first enzyme and an electron transport material. The first enzyme is an enzyme specifically catalyzing a redox reaction of the first analyte. That is, the first analyte is a substrate of the first enzyme. The electron transport material is a material donating or accepting an electron when an analyte is oxidized or reduced. The first reagent layer is disposed in a dry state, for example, in the first measurement chamber. In the case where the sensor has a channel connecting the liquid sample inlet with the first measurement chamber, the first reagent layer may be disposed inside this channel.

The second reagent layer contains a second enzyme but does not need to contain an electron transport material. As described later, this is because the electron transport material contained in the first reagent layer can be utilized again in a redox reaction where the second enzyme acts as a catalyst. The second enzyme is an enzyme specifically catalyzing a redox reaction of the second analyte. That is, the second analyte is a substrate of the second enzyme. The second reagent layer is disposed in a dry state in the second measurement chamber or in a channel connecting the liquid sample inlet with the second measurement chamber.

The first enzyme and the second enzyme are appropriately selected according to an analyte which is a substrate thereof. Examples of these enzymes include glucose oxidase, fructosylamine oxidase, lactate oxidase, urate oxidase, cholesterol oxidase, alcohol oxidase, glutamate oxidase, pyruvate oxidase, NADH oxidase, peroxidase, sarcosine oxidase, glucose dehydrogenase, lactate dehydrogenase, alcohol dehydrogenase, cholesterol dehydrogenase, diaphorase, pyruvate kinase, and acetate kinase. Preferred first enzyme and second enzyme are oxidase and dehydrogenase. It is possible to measure a specific analyte in a liquid sample where various kinds of materials are mixed by utilizing such an enzyme specifically catalyzing a redox reaction of the analyte.

Preferably, the first and second enzymes have different materials as substrates. This is because the present invention is intended to measure different kinds of analytes. Also, preferably, the same electron transport material participates in a reaction where the first enzyme acts as a catalyst and a reaction where the second enzyme acts as a catalyst. Since the electron transport material is shared in the reaction where the first enzyme acts as a catalyst and in the reaction where the second enzyme acts as a catalyst, the electron transport material contained in the first reagent layer can be utilized in measurement of the second analyte. Therefore, the second reagent layer does not need to contain the electron transport material. That is, the present invention is characterized in that the electron transport material oxidized or reduced by reaction with the first analyte is changed into a reductant or an oxidant (referred to as a ‘reusable agent’ hereinafter) that can react with the second analyte.

For example, in the case where the first analyte is glucose and the second analyte is cholesterol, the first enzyme is glucose oxidase, the second enzyme is cholesterol oxidase, and the electron transport material is potassium ferricyanide.

The electron transport material donates or accepts an electron when an analyte is oxidized or reduced by an enzyme. The electron transport material also gives and takes an electron to and from the working electrode or the counter electrode. Examples of the electron transport material include potassium ferricyanide, p-benzoquinone, phenazine methosulfate, ferrocene derivatives, and osmium complex. Preferably, the electron transport material participates in not only a reaction where the first enzyme acts as a catalyst but also a reaction where the second enzyme acts as a catalyst, which will be described later.

The second measurement chamber is a chamber for measuring the second analyte contained in a liquid sample. For measurement of an analyte, an electrode pair of a working electrode and a counter electrode is provided, and a third electrode, for example, a reference electrode maybe further provided in the second measurement chamber. The second measurement chamber and the first measurement chamber are connected with each other by a channel.

The channel connecting the first measurement chamber with the second measurement chamber may have an electrode pair of a working electrode and a counter electrode, and may further have a third electrode, for example, a reference electrode. In the case where the channel connecting the first measurement chamber with the second measurement chamber has the electrode pair of the working electrode and the counter electrode, the second reagent layer is preferably disposed in the second measurement chamber. The electrode pair in the channel is an electrode pair for changing an electron transport material oxidized or reduced by reaction with the first analyte into a reductant or an oxidant (reusable agent) that can react with the second analyte in the liquid sample.

An intermediate chamber may be installed in the channel connecting the first measurement chamber with the second measurement chamber. The intermediate chamber is a chamber for changing an electron transport material reduced or oxidized by reaction with the first analyte into a reusable agent. The intermediate chamber may have an electrode pair of a working electrode and a counter electrode, and may further have a third electrode, for example, a reference electrode.

Preferably, a working electrode and a counter electrode in the sensor are connected to terminals for connecting to an external voltage applying apparatus. The sizes of the surface areas of the working electrode and the counter electrode need not be the same. For example, the surface area of one electrode may be one hundred times or more larger than that of the other electrode. For example, the surface area of one electrode can be made one hundred times or more larger than that of the other electrode by forming one electrode using a porous material. Examples of the porous material include carbon felt. Since almost all of electron transport materials oxidized or reduced by reaction with an analyte can be reduced or oxidized by increasing the surface area of one of the working electrode and the counter electrode, the analyte can be measured rapidly and accurately, and the electron transport material can be rapidly changed into a reusable agent. Preferably, an electrode formed of the porous material is an electrode for reducing or oxidizing the electron transport material oxidized or reduced by reaction with the analyte. That is, in the case of oxidizing the electron transport material, an anode electrode is preferably formed of the porous material. In the case of reducing the electron transport material, a cathode electrode is preferably formed of the porous material.

The working electrode or the counter electrode in the sensor may be covered with a polymer. Examples of the polymer covering the working electrode or the counter electrode include agarose and carboxymethyl cellulose which contain an electrolyte; polyvinyl alcohol; and urethane foam. Since the counter electrode or the working electrode is covered with a polymer, it is difficult for an electron transport material reduced or oxidized at the working electrode or the counter electrode to get close to the vicinity of the other electrode. Therefore, an electron transport material oxidized or reduced by reaction with an analyte can be reduced or oxidized at an even higher rate. Accordingly, the analyte can be measured rapidly and accurately, so that the electron transport material can be rapidly changed into a reusable agent. The electrode covered with a polymer is preferably an electrode for reducing or oxidizing an electron transport material oxidized or reduced by reaction with an analyte. That is, in the case of oxidizing the electron transport material, the anode electrode is preferably covered with a polymer. In the case of reducing the electron transport material, the cathode electrode is preferably covered with a polymer.

A multicomponent analysis sensor of the present invention may have three or more measurement chambers depending on the number of analyte items.

2. Regarding a Method of Measuring Multiple Components According to the Present Invention

Hereinafter, a method of measuring multiple components utilizing the multicomponent analysis sensor having the above-described construction will be described in detail.

The method of measuring multiple components utilizing the multicomponent analysis sensor having the above-described construction includes A) supplying a liquid sample to the liquid sample inlet, B) transporting the liquid sample to the first measurement chamber, C) oxidizing or reducing an electron transport material by allowing a first analyte in the liquid sample, the first enzyme, and the electron transport material to react with one another, D) applying a potential to the working electrode and the counter electrode of the first measurement chamber to which the liquid sample has been transported, E) measuring the first analyte by measuring a current flowing through the electrode pair of the first measurement chamber, F) changing the electron transport material oxidized or reduced in C) into a reductant or an oxidant (reusable agent) reactable with the second analyte in the liquid sample, G) transporting the liquid sample to the second measurement chamber, H) allowing the second analyte, the second enzyme, and the electron transport material (or reusable agent) to react with one another to oxidize or reduce the electron transport material, I) applying a potential to the working electrode and the counter electrode of the second measurement chamber to which the liquid sample has been transported, and J) measuring the second analyte by measuring a current flowing through the electrode pair of the second measurement chamber.

In process A), the liquid sample is supplied to the liquid sample inlet.

In process B), the supplied liquid sample is transported to the first measurement chamber. The method of transporting the liquid sample is not particularly limited as far as the method can transport the liquid sample to the first measurement chamber. In the case where the liquid sample inlet and the first measurement chamber communicate with each other via a channel, the liquid sample can be transported utilizing any of a transporting method utilizing centrifugal force, a transporting method utilizing a capillary phenomenon, a transporting method utilizing a pressure of a pump or the like, a method where a valve is disposed that can control transportation of a liquid sample in a channel connecting the liquid sample inlet with the first measurement chamber, and the like. When the liquid sample is transported to the first measurement chamber via the channel, the first reagent layer disposed in the first measurement chamber or in the channel dissolves. As a result, the first enzyme and the electron transport material contained in the first reagent layer disperse into the liquid sample.

In process C), the first analyte in the liquid sample and the electron transport material are allowed to react with each other with the first enzyme utilized as a catalyst. The reaction is a redox reaction. As a result of the reaction, the electron transport material is oxidized or reduced. To accurately measure the analyte, the analyte and the electron transport material are preferably allowed to react with each other until the reaction almost reach equilibrium.

After that, in process D), a potential is applied to the working electrode and the counter electrode disposed in the first measurement chamber to which the liquid sample has been transported. Any potential may be applied as far as the potential can reduce or oxidize again the electron transport material oxidized or reduced in process C). For example, a voltage generated between the electrodes by the applied potential is preferably +0.1 V or more or −0.1 V or less of a standard oxidation-reduction potential of the electron transport material.

Process E) measures a current generated when the electron transport material oxidized or reduced in process C) is reduced or oxidized at the working electrode or the counter electrode to which the potential has been applied. The amount of the first analyte can be measured based on this current value.

In process F), the electron transport material oxidized or reduced in process C) is changed into a reductant or an oxidant (reusable agent) that can react with the second analyte. By this process, the electron transport material can be re-utilized in the measurement of the second analyte. For example, in the case where the electron transport material required for a reaction with the second analyte is an oxidant, the electron transport material is changed into an oxidant in this process. On the other hand, in the case where the electron transport material required for a reaction with the second analyte is a reductant, the electron transport material is changed into a reductant in this process. To change the electron transport material oxidized or reduced in process C) into a reusable agent, the electron transport material oxidized or reduced in process C) is reversely reduced or oxidized by the electrode to which a potential has been applied. The electrode reducing or oxidizing an electron transport material may be any of the electrode pair of the first measurement chamber, the electrode pair of the channel connecting the first measurement chamber with the second measurement chamber, and the electrode pair of the intermediate chamber.

In process F), a current flowing through an electrode pair changing an electron transport material into a reusable agent may be measured. By doing so, whether the electron transport material has been changed into the reusable agent can be checked. Whether the electron transport material has been changed into the reusable agent can be checked by confirming that the current value per unit time does not change, that is, whether the reaction of the electron transport material at a working electrode or a counter electrode has reached equilibrium.

Also, even when all of electron transport materials do not change into re-usable agents during this process, a measurement result of the second analyte can be corrected utilizing the current value measured in this process.

In process G), the liquid sample is transported to the second measurement chamber via a channel. The method of transporting the liquid sample may be the same as the method described in process B). When the liquid sample is transported to the second measurement chamber via the channel, the second reagent layer disposed in the second measurement chamber or in the channel connected to the second measurement chamber is dissolved. As a result, the second enzyme contained in the second reagent layer disperses into the liquid sample.

In process H), the second analyte in the liquid sample and an electron transport material as a reusable agent are allowed to react with each other with the second enzyme utilized as a catalyst. The reaction is a redox reaction. As a result of the reaction, the electron transport material is oxidized or reduced. To accurately measure the analyte, the analyte and the electron transport material are preferably allowed to react with each other until the reaction almost reach equilibrium.

In process I), a potential is applied to the working electrode and the counter electrode disposed in the second measurement chamber to which the liquid sample has been transported. Any potential may be applied as far as the potential can reduce or oxidize the electron transport material. For example, a voltage generated by the applied potential is preferably +0.1 V or more or −0.1 V or less of a standard oxidation-reduction potential of the electron transport material.

In Process J), a current generated at the time when the electron transport material reduced or oxidized in process H) is oxidized or reduced at the working electrode or the counter electrode to which the potential has been applied is measured. The amount of the second analyte can be measured based on this current value. A more accurate amount of the second analyte can be obtained by correcting the current value measured in this process with the current value measured in process F).

A process of measuring another analyte may further be added depending on the number of measurement chambers.

As described above, since the present invention uses a liquid sample utilized for measuring one kind of analyte in order to measure another kind of analyte, a plurality of analytes can be measured with a very small amount of liquid sample. In addition, since an electron transport material utilized for measuring one kind of analyte can also be utilized for measuring another kind of analyte, multiple components can be measured at lower costs.

Hereinafter, embodiments of the present invention will be described in detail with reference to the drawings.

### Embodiment 1

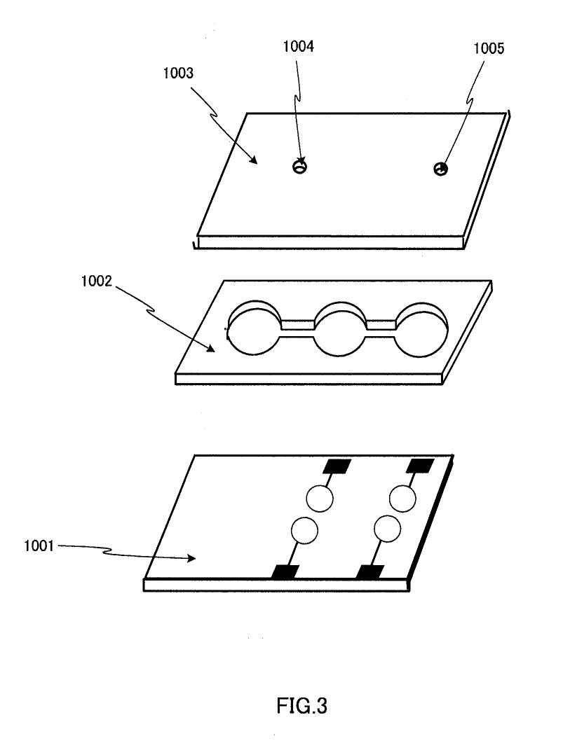

FIG. 3 is an exploded perspective view of a multicomponent analysis sensor according to Embodiment 1 of the present invention.

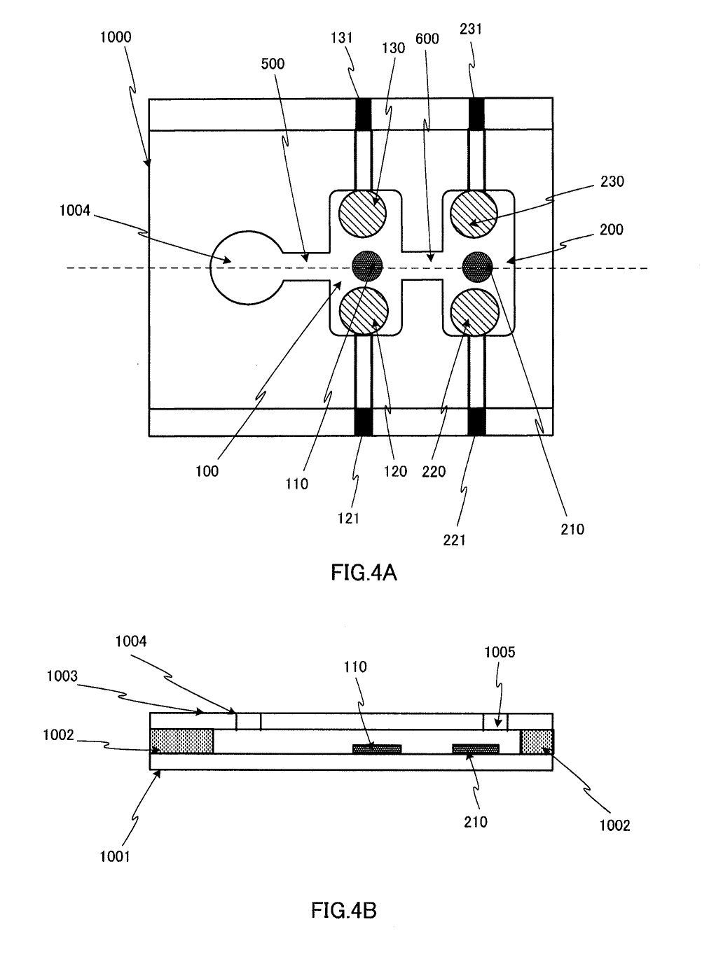

Referring to FIG. 3, multicomponent analysis sensor 1000 (refer to FIG. 4A) includes substrate 1001, spacer 1002, and upper substrate 1003.

FIG. 4A is a plan view of multicomponent analysis sensor 1000 according to Embodiment 1 of the present invention. FIG. 4B is a cross-sectional view of multicomponent analysis sensor 1000 according to Embodiment 1 of the present invention.

Referring to FIG. 4, multicomponent analysis sensor 1000 includes liquid sample inlet 1004, first measurement chamber 100, first reagent layer 110, second measurement chamber 200, second reagent layer 210, air hole 1005, first channel 500 connecting liquid sample inlet 1004 with first measurement chamber 100, and second channel 600 connecting first measurement chamber 100 with second measurement chamber 200. First measurement chamber 100 has an electrode pair of working electrode 120 and counter electrode 130. Working electrode 120 is connected to working electrode terminal 121, and counter electrode 130 is connected to counter electrode terminal 131. Likewise, second measurement chamber 200 has an electrode pair of working electrode 220 and counter electrode 230. Working electrode 220 is connected to working electrode terminal 221, and counter electrode 230 is connected to counter electrode terminal 231. First reagent layer 110 is disposed in first measurement chamber 100. Second reagent layer 210 is disposed in second measurement chamber 200.

Substrate 1001 is a plate serving as the bottom of first channel 500, the bottom of second channel 600, the bottom of first measurement chamber 100, and the bottom of second measurement chamber 200. Working electrodes 120 and 220, counter electrodes 130 and 230, working electrode terminals 121 and 221, and counter electrode terminals 131 and 231 are formed in advance on substrate 1001.

Upper substrate 1003 is a plate serving as the top of first channel 500, the top of second channel 600, the top of first measurement chamber 100, and the top of second measurement chamber 200. Upper substrate 1003 has liquid sample inlet 1004 and air hole 1005.

Liquid sample inlet 1004 is an opening through which a liquid sample is injected.

Air hole 1005 is an opening for exhausting air inside the measurement chambers and the channel when the liquid sample is injected.

First measurement chamber 100 is a chamber for measuring a first analyte in the liquid sample.

Second measurement chamber 200 is a chamber for measuring a second analyte in the liquid sample.

First channel 500 is a channel for transporting the liquid sample from liquid sample inlet 1004 to first measurement chamber 100.

Second channel 500 is a channel for transporting the liquid sample from first measurement chamber 100 to second measurement chamber 200.

A potential is applied to the electrode pair of working electrodes 120, 220 and the electrode pair of counter electrodes 130, 230 when an analyte is measured in the measurement chamber. Working electrode terminal 121, 221 and counter electrode 131, 231 are connected to an external potential applying apparatus to apply a potential to working electrode 120, 220 and counter electrode 130, 230.

First reagent layer 110 contains a first enzyme and an electron transport material. The first enzyme is an enzyme specifically catalyzing a redox reaction of the first analyte. The first analyte can be measured from the liquid sample where various kinds of materials are mixed by utilizing an enzyme specifically catalyzing the redox reaction of the first analyte. For example, the first enzyme is glucose oxidase. The electron transport material contained in first reagent layer 110 is a material that donates or accepts an electron when an analyte is oxidized or reduced. The electron transport material is potassium ferricyanide, for example.

Second reagent layer 210 contains a second enzyme. The second enzyme is an enzyme specifically catalyzing a redox reaction of the second analyte. For example, the second enzyme is lactate dehydrogenase.

The liquid sample is supplied to liquid sample inlet 1004 of multicomponent analysis sensor 1000, and various kinds of analytes contained in the liquid sample can be measured.

A method of measuring multiple components utilizing multicomponent analysis sensor 1000 will be described.

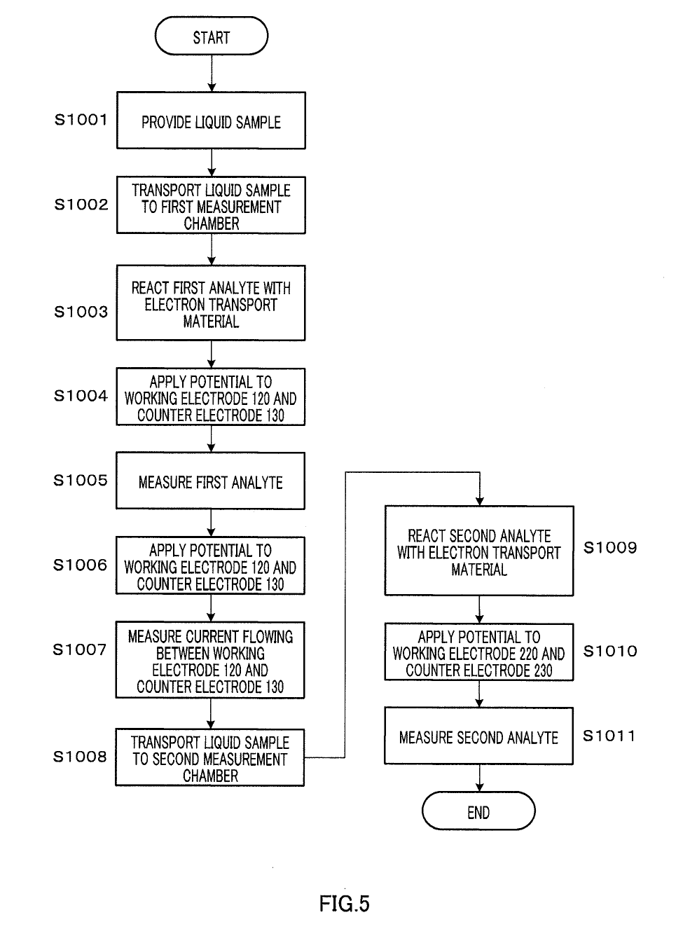

FIG. 5 is a flowchart illustrating a method of measuring multiple components using a multicomponent analysis sensor having the above-described construction.

First, instep S1001, a liquid sample is supplied to liquid sample inlet 1004.

In step S1002, the liquid sample supplied instep S1001 is transported to first measurement chamber 100 via first channel 500. When the liquid sample is transported to first measurement chamber 100 via first channel 500, first reagent layer 110 disposed in first measurement chamber 100 dissolves. As a result, the first enzyme and the electron transport material contained in first reagent layer 110 disperse into the liquid sample.

In step S1003, the first analyte in the liquid sample and the electron transport material are allowed to react with each other utilizing the first enzyme as a catalyst. As a result of the reaction, the electron transport material is oxidized or reduced. To accurately measure the analyte, the analyte and the electron transport material are preferably allowed to react with each other until the almost reach equilibrium.

After the reaction terminates, in step S1004, a potential is applied to working electrode 120 and counter electrode 130 of first measurement chamber 100 to which the liquid sample has been transported. Any potential may be applied as far as the potential can reduce or oxidize again the electron transport material oxidized or reduced in step S1003. For example, a voltage between working electrode 120 and counter electrode 130 generated by the applied potential is preferably +0.1 V or more or −0.1 V or less of a standard oxidation-reduction potential of the electron transport material.

In step S1005, a current generated as a result that the electron transport material oxidized or reduced in step S1003 is reduced or oxidized at working electrode 120 or counter electrode 130 to which a potential is applied is measured. The amount of the first analyte is measured utilizing this current value.

In step S1006, a potential is applied to working electrode 120 and counter electrode 130 of first measurement chamber 100. With this operation, the electron transport material oxidized or reduced in step S1003 is changed into a reductant or an oxidant (reusable agent) that can react with the second analyte. By this step, the electron transport material is changed to be reusable. Step S1004 and step S1006 may be performed simultaneously.

In step S1007, a current flowing between working electrode 120 and counter electrode 130 is measured. Step S1007 and step S1005 can be performed simultaneously. By this step, for example, it can be checked that the electron transport material oxidized or reduced in step S1003 has changed into a reusable agent. Specifically, it is confirmed that the current value per unit time does not change, that is, that the reaction of the electron transport material at working electrode 120 or counter electrode 130 has reached equilibrium. A current value measured in step S1011 described layer may be corrected utilizing the current value measured in this step.

After the current is measured in step S1007, the liquid sample in first measurement chamber 100 is transported to second measurement chamber 200 via second channel 600 in step S1008. When the liquid sample is transported to second measurement chamber 200 via second channel 600, second reagent layer 210 disposed in second measurement chamber 200 dissolves. As a result, the second enzyme contained in second reagent layer 210 disperses into the liquid sample.

In step S1009, the second analyte in the liquid sample and the electron transport material as the reusable agent are allowed to react with each other utilizing the second enzyme as a catalyst. The reaction is a redox reaction. As a result of the reaction, the electron transport material is oxidized or reduced. To accurately measure the analyte, the analyte and the electron transport material are preferably allowed to react with each other until the reaction almost reach equilibrium.

After step S1009, a potential is applied to working electrode 220 and counter electrode 230 of second measurement chamber 200 to which the liquid sample has been transported in step S1010. Any potential may be applied as far as the potential can reduce or oxidize again the electron transport material oxidized or reduced in step S1009. For example, a voltage generated by the applied potential is preferably +0.1 V or more or −0.1 V or less of a standard oxidation-reduction potential of the electron transport material.

In step S1011, a current generated as a result that the electron transport material oxidized or reduced in step S1009 is reduced or oxidized at working electrode 220 or counter electrode 230 to which a potential is applied is measured. The amount of the second analyte can be measured utilizing this current value. The current value measured in this step may be corrected based on the current value measured in step S1007. Here, ‘correction’ means subtracting the current value measured in step S1007 from the current value measured in this step. Since the current value measured in step S1007 is a so-called background current value, the amount of the second analyte can be more accurately measured by utilizing the corrected current value.

As described above, in the present embodiment, since the liquid sample that has been utilized for measuring the first analyte is utilized in order to measure the second analyte, a plurality of analytes can be measured with a very small amount of liquid sample.

In addition, since the electron transport material that has been utilized for measuring the first analyte can also be utilized for measuring the second analyte, the amount of a reagent can be reduced and multiple components can be measured at lower costs.

### Embodiment 2

In Embodiment 2, an example of a multicomponent analysis sensor having an electrode pair disposed in a second channel is described.

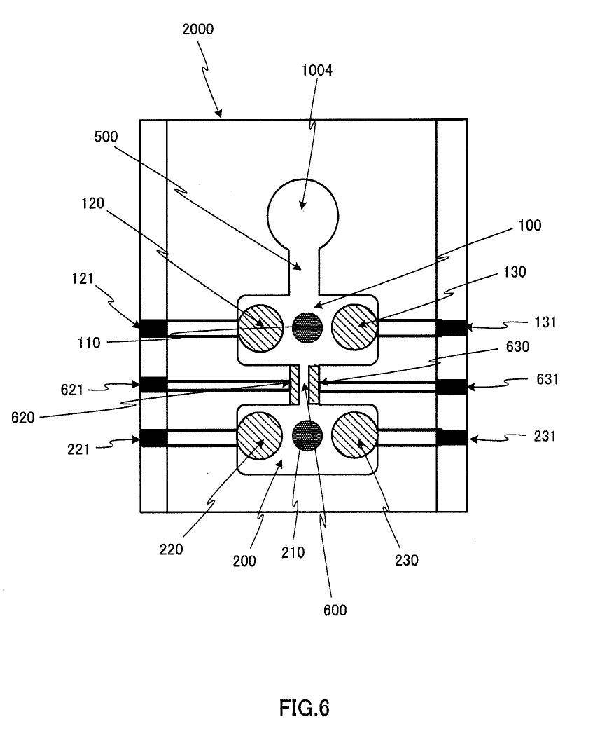

FIG. 6 is a plan view of multicomponent analysis sensor 2000 according to Embodiment 2.

Multicomponent analysis sensor 2000 includes liquid sample inlet 1004, first measurement sensor 100, first reagent layer 110, second measurement chamber 200, second reagent layer 210, air hole 1005 (refer to FIG. 3), first channel 500, and second channel 600. Multicomponent analysis sensor 2000 also includes working electrodes 120, 620, 220, counter electrodes 130, 630, 230, working electrode terminals 121, 621, 221, and counter electrode terminals 131, 631, 231.

The elements of multicomponent analysis sensor 2000 other than working electrode 620, counter electrode 630, working electrode terminal 621, and counter electrode terminal 631 are the same as those of multicomponent analysis sensor 1000. The reference numerals are assigned to the same elements, and descriptions thereof are not repeated.

Working electrode 620 and counter electrode 630 are disposed in second channel 600. Working electrode 620 is connected to working electrode terminal 621, and counter electrode 630 is connected to counter electrode terminal 631.

Working electrode terminal 621 and counter electrode terminal 631 are terminals for connecting to an external voltage applying apparatus.

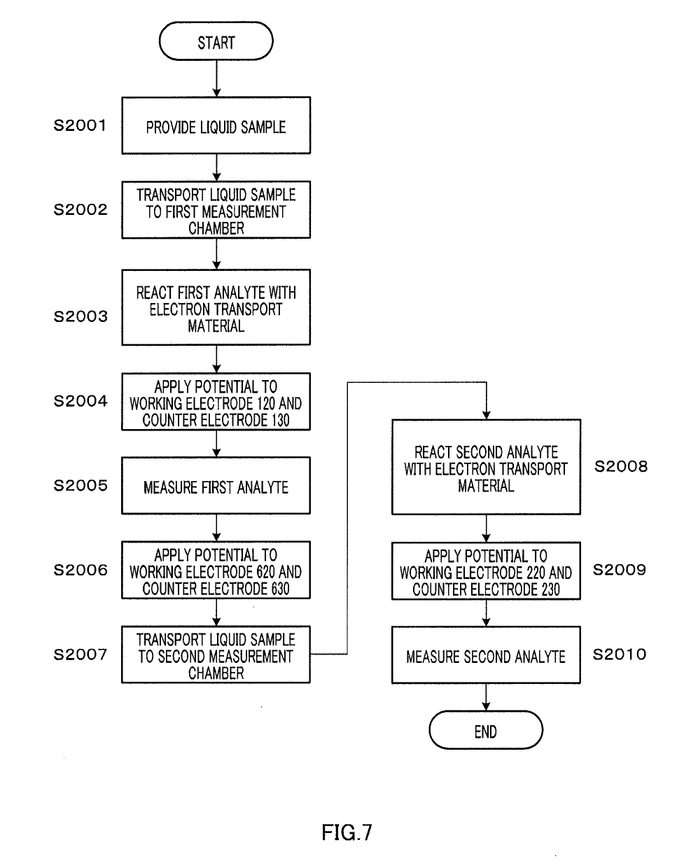

Hereinafter, a method of measuring multiple components using multicomponent analysis sensor 2000 will be described with reference to FIG. 7.

FIG. 7 is a flowchart illustrating a method of measuring multiple components using multicomponent analysis sensor 2000.

Steps S2001 to 2005 included in the method of measuring multiple components using multicomponent analysis sensor 2000 correspond to steps S1001 to 1005, respectively.

In step S2006, a potential is applied to working electrode 620 and counter electrode 630. Any potential maybe applied as far as the potential can reduce or oxidize again an electron transport material oxidized or reduced in step S2003. For example, a voltage generated by the applied potential is preferably +0.1 V or more or −0.1 V or less of a standard oxidation-reduction potential of the electron transport material.

In step S2007, the liquid sample in first measurement chamber 100 is transported to second measurement chamber 200 via second channel 600. While the liquid sample is transported via second channel 600, the electron transport material in the liquid sample is changed into a reusable agent by working electrode 620 or counter electrode 630 to which the potential has been applied in second channel 600. When the liquid sample is transported to second measurement chamber 200 via second channel 600, second reagent layer 210 disposed in second measurement chamber 200 dissolves. As a result, a second enzyme contained in second reagent layer 210 disperses into the liquid sample. In this step, a current flowing between working electrode 620 and counter electrode 630 may be measured, and a current value measured in step S2010 may be corrected utilizing the measured current value.

Steps S2008 to 2010 after the liquid sample is transported to second measurement chamber 200 correspond to steps S1009 to 1011, respectively.

As described above, the multicomponent analysis sensor according to the present embodiment can perform a more accurate measurement in each measurement chamber in addition to the effects of Embodiment 1 by installing the electrode pair for changing an electron transport material into a reusable agent in the second channel. Therefore, multiple components can be measured more accurately.

In addition, since the electrode pair is installed in the channel, liquid sample transportation and reaction of changing an electron transport material into a reusable agent can be performed simultaneously. Therefore, measurement time can be shortened.

### Embodiment 3

In Embodiment 3, a multicomponent analysis sensor having an intermediate chamber is described.

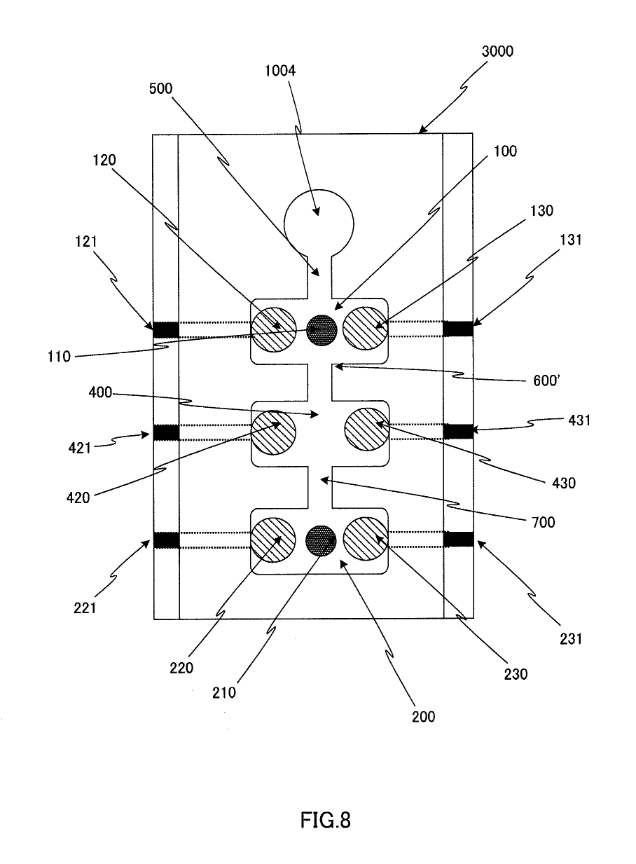

FIG. 8 is a plan view of multicomponent analysis sensor 3000 according to Embodiment 3.

Multicomponent analysis sensor 3000 includes liquid sample inlet 1004, first measurement sensor 100, first reagent layer 110, second measurement chamber 200, second reagent layer 210, intermediate chamber 400, air hole 1005 (refer to FIG. 3), first channel 500, second channel 600′, third channel 700, working electrodes 120, 420, 220, counter electrodes 130, 430, 230, working electrode terminals 121, 421, 221, and counter electrode terminals 131, 431, 231.

The elements of multicomponent analysis sensor 3000 other than intermediate chamber 400, working electrode 420, counter electrode 430, working electrode terminal 421, counter electrode terminal 431, second channel 600′, and third channel 700 are the same as those of multicomponent analysis sensor 1000. The same reference numerals are assigned to the same elements, and descriptions thereof are not repeated.

In intermediate chamber 400, a reaction of changing an electron transport material oxidized or reduced by reaction with a first analyte into a reusable agent proceeds. Intermediate chamber 400 has an electrode pair of working electrode 420 and counter electrode 430. Working electrode 420 is connected to working electrode terminal 421, and counter electrode 430 is connected to counter electrode terminal 431.

Second channel 600′ connects first measurement chamber 100 with intermediate chamber 400. Third channel 700 connects intermediate chamber 400 with second measurement chamber 200.

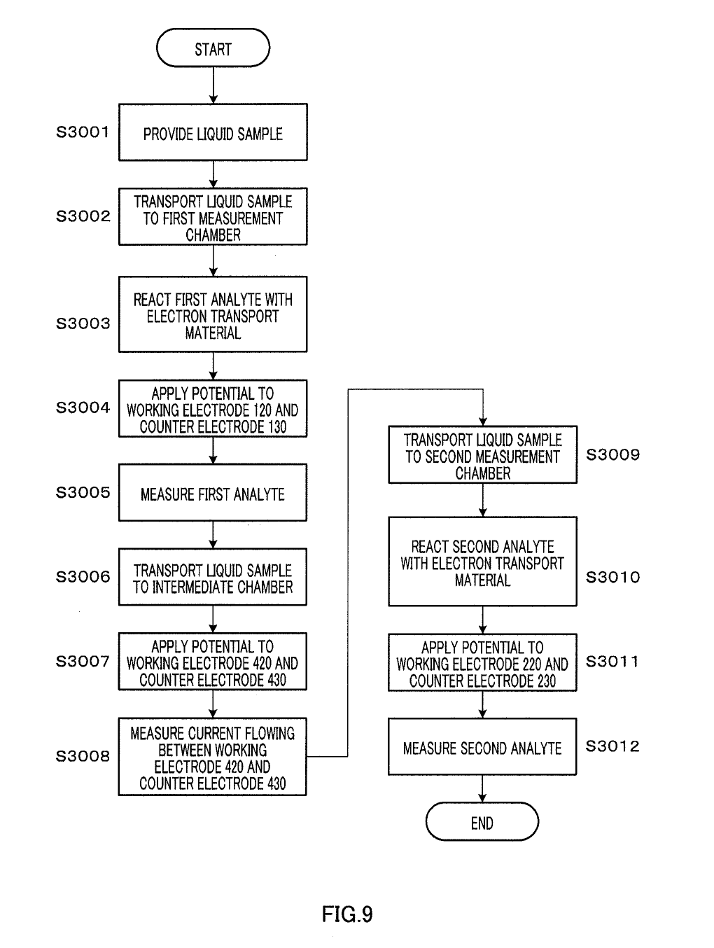

Hereinafter, a method of measuring multiple components using multicomponent analysis sensor 3000 will be described with reference to FIG. 9.

FIG. 9 is a flowchart illustrating a method of measuring multiple components using multicomponent analysis sensor 3000.

Steps S3001 to 3005 included in the method of measuring multiple components using multicomponent analysis sensor 3000 according to the present embodiment correspond to steps S1001 to 1005, respectively.

In step S3006, the liquid sample in first measurement chamber 100 is transported to intermediate chamber 400 via second channel 600′.

In step S3007, a potential is applied to working electrode 420 and counter electrode 430 of intermediate chamber 400. With this operation, the electron transport material oxidized or reduced in step S3003 is changed into a reusable agent. By this step, the electron transport material is changed to be reusable.

In step S3008, a current flowing between working electrode 420 and counter electrode 430 is measured. By this, for example, it can be checked that the electron transport material oxidized or reduced in step S3003 has changed into a reusable agent. Specifically, it is confirmed that the current value per unit time does not change, that is, that the reaction of the electron transport material at working electrode 420 or counter electrode 430 has reached equilibrium. A current value measured in step S3012 may be corrected utilizing the current value measured in this step.

In step S3009, the liquid sample in intermediate chamber 400 is transported to second measurement chamber 200 via third channel 700. When the liquid sample is transported to second measurement chamber 200 via third channel 700, second reagent layer 210 disposed in second measurement chamber 200 dissolves. As a result, the second enzyme contained in second reagent layer 210 disperses into the liquid sample.

Steps S3010 to 3012 after the liquid sample is transported to second measurement chamber 200 correspond to steps S1009 to 1011, respectively.

As described above, the multicomponent analysis sensor according to the present embodiment can reliably change an electron transport material oxidized or reduced by reaction with the first analyte into a reusable agent in addition to the effects of Embodiment 1 by installing the intermediate chamber between the first measurement chamber and the second measurement chamber. Thus, a background current can be reduced during measurement at the second measurement chamber. Therefore, the second analyte can be measured more accurately.

### Embodiment 4

In Embodiment 4, a multicomponent analysis sensor where a counter electrode of an intermediate chamber is covered with a polymer is described.

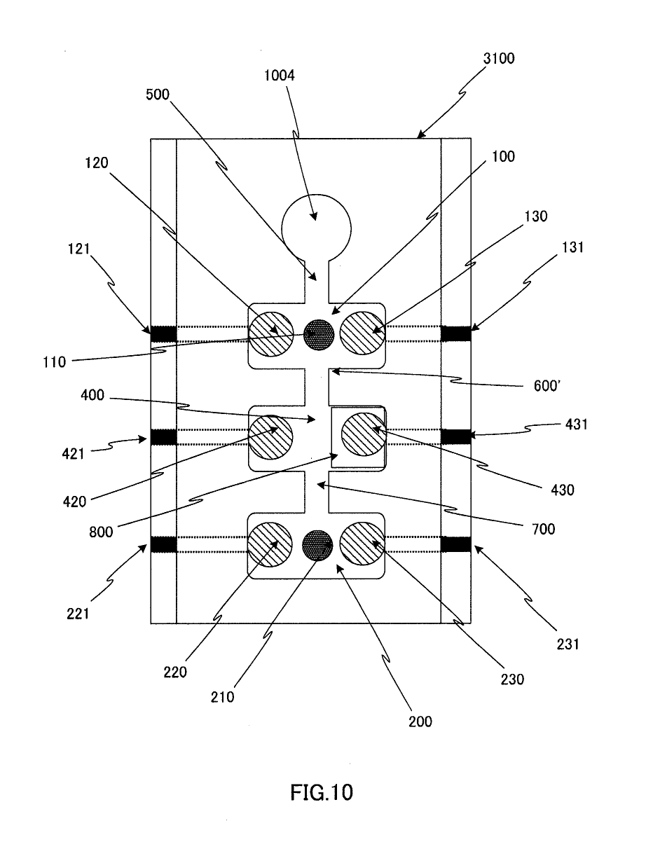

FIG. 10 is a plan view of multicomponent analysis sensor 3100 according to Embodiment 4.

Multicomponent analysis sensor 3100 includes liquid sample inlet 1004, first measurement sensor 100, first reagent layer 110, second measurement chamber 200, second reagent layer 210, intermediate chamber 400, air hole 1005 (refer to FIG. 3), first channel 500, second channel 600′, third channel 700, working electrodes 120, 420, 220, counter electrodes 130, 430, 230, working electrode terminals 121, 421, 221, counter electrode terminals 131, 431, 231, and polymer 800.

The elements of multicomponent analysis sensor 3100 other than polymer 800 are the same as those of multicomponent analysis sensor 3000. The same reference numerals are assigned to the same elements, and descriptions thereof are not repeated.

Polymer 800 covers counter electrode 430. Examples of polymer 800 include agarose and carboxymethylcellulose which contain an electrolyte; polyvinylalcohol; urethane foam, etc.

In the present embodiment, counter electrode 430 serves as an electrode for changing an electron transport material oxidized or reduced by reaction with a first analyte into a reusable agent.

It is difficult for an electron transport material changed into a reusable agent at counter electrode 430 to get close to the vicinity of working electrode 420 due to polymer 800. Accordingly, the electron transport material can be changed into a reusable agent at a higher rate. By this, a background current can be reduced during measurement at the second measurement chamber, and the second analyte can be measured more accurately.

Although an example where the counter electrode of the intermediate chamber is covered with a polymer is described in the present embodiment, the working electrode may be covered with a polymer in the case where the working electrode serves as an electrode for changing an electron transport material into a reusable agent.

A method of measuring multiple components using multicomponent analysis sensor 3100 is the same as the method of measuring multiple components using the multicomponent analysis sensor 3000.

### Embodiment 5

In Embodiment 5, a multicomponent analysis sensor where the surface area of a working electrode of an intermediate chamber is greater than the surface area of a counter electrode is described.

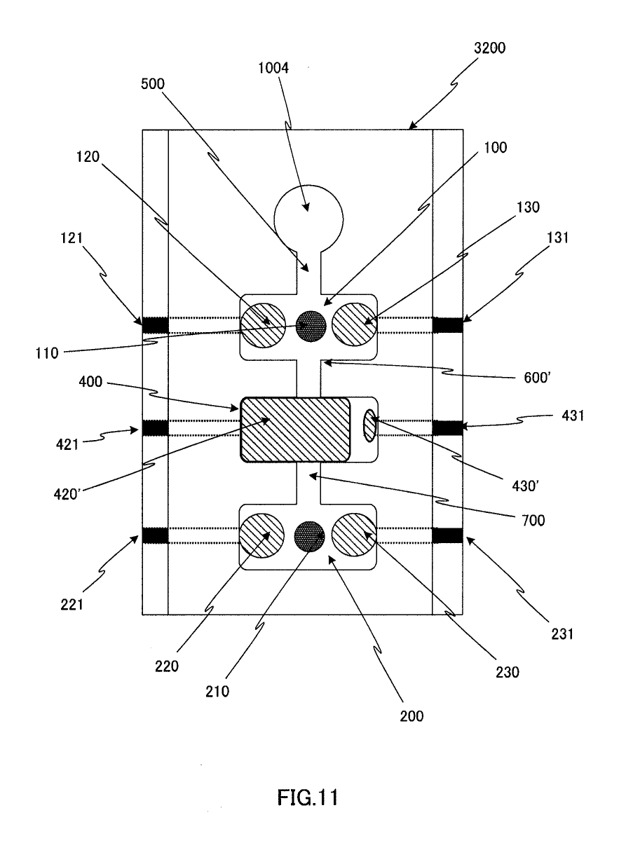

FIG. 11 is a plan view of multicomponent analysis sensor 3200 according to Embodiment 5.

Multicomponent analysis sensor 3200 includes liquid sample inlet 1004, first measurement sensor 100, first reagent layer 110, second measurement chamber 200, second reagent layer 210, intermediate chamber 400, air hole 1005 (refer to FIG. 3), first channel 500, second channel 600′, third channel 700, working electrodes 120, 420′, 220, counter electrodes 130, 430′, 230, working electrode terminals 121, 421, 221, and counter electrode terminals 131, 431, 231.

The elements of multicomponent analysis sensor 3200 other than working electrode 420′ and counter electrode 430′ are the same as those of multicomponent analysis sensor 3000. The same reference numerals are assigned to the same elements, and descriptions thereof are not repeated.

Intermediate chamber 400 has working electrode 420′ and counter electrode 430′. Working electrode 420′ serves as an electrode for reducing or oxidizing an electron transport material oxidized or reduced by reaction with a first analyte.

The surface area of working electrode 420′ is preferably one hundred times or more larger than the surface area of counter electrode 430′. For example, it is possible to make the surface area of working electrode 420′ one hundred times or more larger than the surface area of counter electrode 430′ by making an area inside intermediate chamber 400 occupied by working electrode 420′ larger than that occupied by counter electrode 430′ , or forming the working electrode using a porous material.

It is possible to swiftly reduce or oxidize an electron transport material by making the surface area of working electrode 420′ larger than the surface area of counter electrode 430′.

Although an example where the working electrode of the intermediate chamber is formed of a porous material has been described in the present embodiment, the counter electrode or working electrode in the measurement chamber or in channel may be formed of a porous material. By making the counter electrode or the working electrode of the measurement chamber porous, rapid measurement can be achieved.

### Embodiment 6

In Embodiment 6, a multicomponent analysis sensor having three measurement chambers and an working electrode larger than a counter electrode is described.

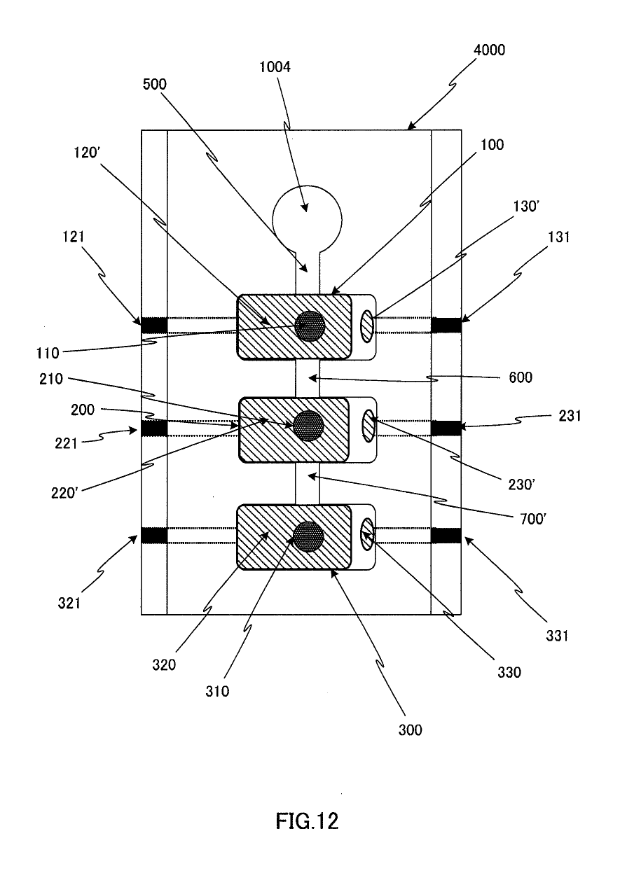

FIG. 12 is a plan view of multicomponent analysis sensor 4000 according to Embodiment 6 of the present invention.

Multicomponent analysis sensor 4000 includes liquid sample inlet 1004, first measurement sensor 100, first reagent layer 110, second measurement chamber 200, second reagent layer 210, third measurement chamber 300, third reagent layer 310, air hole 1005 (refer to FIG. 3), first channel 500, second channel 600, third channel 700′, working electrodes 120′, 220′, 320, counter electrodes 130′, 230′, 330, working electrode terminals 121, 221, 321, and counter electrode terminals 131, 231, 331.

The elements of multicomponent analysis sensor 4000 other than third measurement chamber 300, third reagent layer 310, channel 700′, working electrodes 120′, 220′, 320, counter electrodes 130′, 230′, and 330, working electrode terminal 321, and counter electrode terminal 331 are the same as those of multicomponent analysis sensor 1000. The same reference numerals are assigned to the same elements, and descriptions thereof are not repeated.

Third measurement chamber 300 is a chamber for measuring a third analyte. Third reagent layer 310 is disposed in third measurement chamber 300. The third reagent layer contains a third enzyme. The third enzyme is an enzyme specifically catalyzing a redox reaction of the third analyte.

Third channel 700′ is a channel connecting second measurement chamber 200 with third measurement chamber 300.

Working electrodes 120′, 220′, and 320 serve as electrodes for reducing or oxidizing an electron transport material oxidized or reduced by reaction with the analyte.

The surface areas of working electrodes 120′, 220′, and 320 are preferably one hundred times or more larger than the surface areas of counter electrodes 130′, 230′, and 330, respectively. To make the surface areas of working electrodes 120′, 220′, and 320 one hundred times or more larger than the surface areas of counter electrodes 130′, 230′, and 330, respectively, the method described in Embodiment 5 can be used, for example. It is possible to swiftly reduce or oxidize an electron transport material by making the surface area of the working electrode larger than the surface area of the counter electrode. Working electrode 320 is connected to working electrode terminal 321, and counter electrode 330 is connected to counter electrode terminal 331.

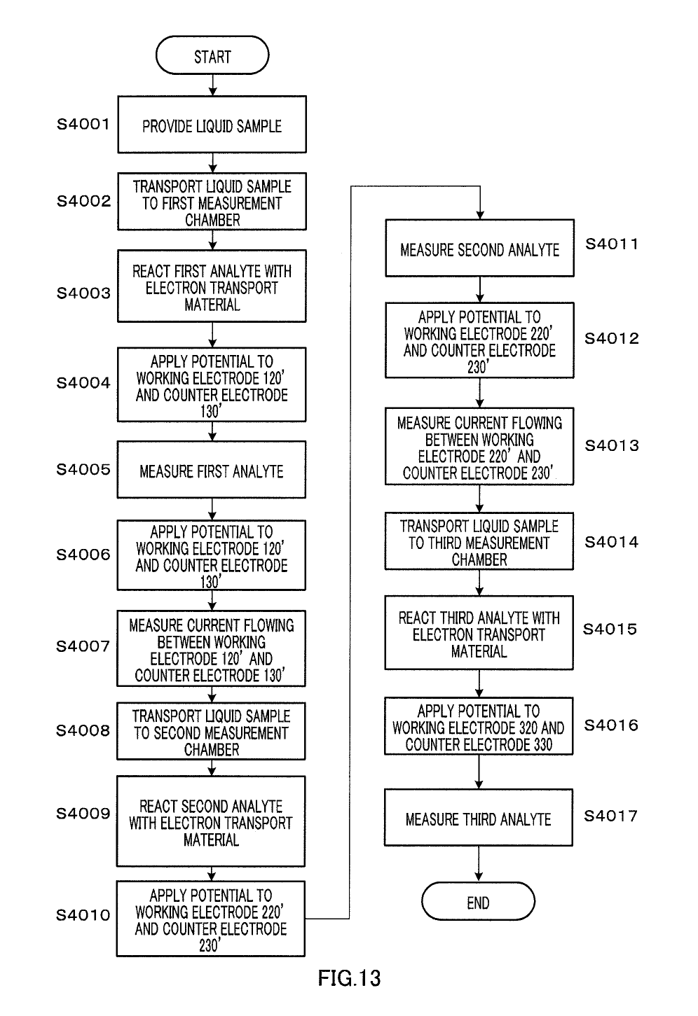

Hereinafter, a method of measuring multiple components using multicomponent analysis sensor 4000 will be described with reference to FIG. 13. FIG. 13 is a flowchart illustrating the method of measuring multiple components using multicomponent analysis sensor 4000.

Steps S4001 to 4011 included in the method of measuring multiple components using the multicomponent analysis sensor according to the present embodiment correspond to steps S1001 to 1011, respectively.

In step S4012, a potential is applied to working electrode 220′ and counter electrode 230′ of second measurement chamber 200. By this, an electron transport material oxidized or reduced in step S4009 is changed into a reductant or an oxidant (reusable agent) that can react with a third analyte. By this step, the electron transport material is changed to be reusable. Step S4010 and step S4012 may be performed simultaneously.

In step S4013, a current flowing between working electrode 220′ and the counter electrode 230′ is measured. Step S4011 and step S4013 can be performed simultaneously. By this step, it can be checked, for example, that the electron transport material oxidized or reduced in step S4009 has changed into a reusable agent. Specifically, it is confirmed that the current value per unit time does not change, that is, that the reaction of the electron transport material at working electrode 220′ or counter electrode 230′ has reached equilibrium. A current value measured in step S4016 may be corrected utilizing the current value measured in this step.

Steps S4014 to 4017 correspond to steps S4008 to 4011 except that working electrode 320, counter electrode 330, third reagent layer, and channel 700′ are used instead of working electrode 220, counter electrode 230, second reagent layer 210, and channel 600.

In the case where measurement chambers are further added as the number of analytes increases, steps S4012 to 4017 are further repeated.

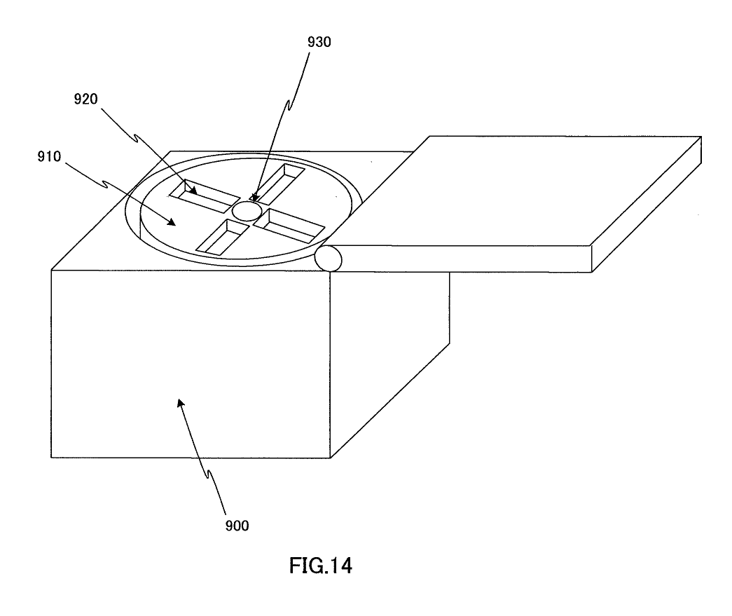

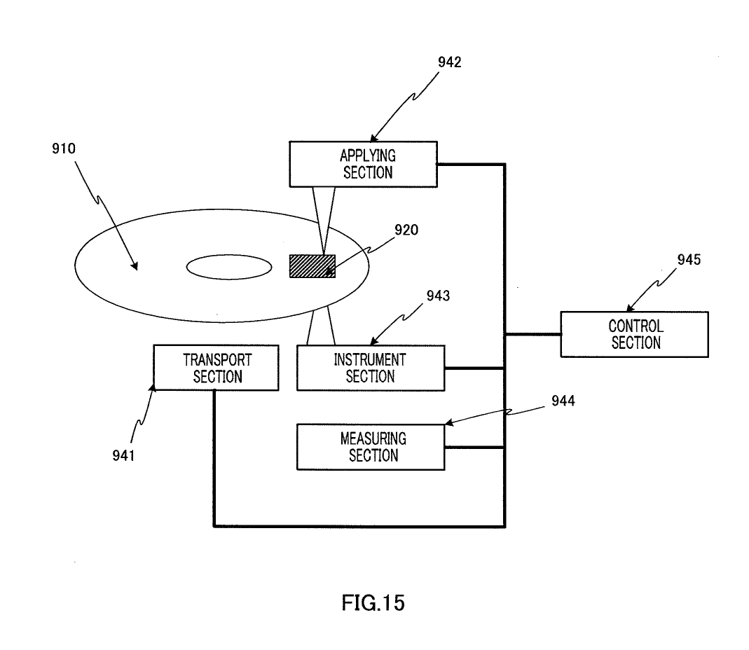

The multicomponent analysis sensor according to any one of Embodiments 1 to 6 may be mounted onto an analysis apparatus illustrated in FIGS. 14 and 15 to measure multiple components.

FIG. 14 is a schematic view of an analysis apparatus. Referring to FIG. 14, analysis apparatus 900 includes rotatable tray 910, installation section 920 on which a sensor is mounted, and rotational shaft 930.

FIG. 15 is a block diagram illustrating the construction of analysis apparatus 900 illustrated in FIG. 14. Referring to FIG. 15, analysis apparatus 900 (refer to FIG. 14) includes transport section 941, applying section 942, instrument section 943, measuring section 944, and control section 945. Transport section 941 transports a liquid sample in a sensor using rotation. Applying section 942 applies a potential to an electrode pair in the sensor. Instrument section 943 measures a current flowing through the electrode pair in the sensor. Measuring section 944 measures the amount of an analyte in a liquid sample from a current value obtained by instrument section 943. Control section 945 controls transport section 941, applying section 942, instrument section 943, and measuring section 944.

Hereinafter, the present invention is described in more detail with reference to an example. The example is not intended to limit the scope of the present invention.

### Example

In the present example, an example of a multicomponent analysis sensor for measuring glucose, lactic acid, and cholesterol is described. The multicomponent analysis sensor according to the present example has the structure described in Embodiment 6.

### [Manufacturing of Multicomponent Analysis Sensor]

First, a method of manufacturing the multicomponent analysis sensor used in the present example is described. The multicomponent analysis sensor according to the present example is intended to measure the amount of glucose in the first measurement chamber, the amount of lactic acid in the second measurement chamber, and the amount of cholesterol in the third measurement chamber.

(Manufacturing of Substrate)

A pattern of electrodes and terminals to be connected thereto are prepared by printing silver paste on a substrate (8 cm×4 cm) formed of polyethyleneterephthalate by means of screen printing. Electrode pairs of a working electrode and a counter electrode are formed by further printing conductive carbon paste containing a resin binder on the substrate. The working electrodes are connected to corresponding working electrode terminals. The counter electrodes are connected to corresponding counter electrode terminals.

Subsequently, the electrodes are partially covered by printing insulating paste on the substrate, and the shapes and areas of the exposed surfaces of the electrodes are adjusted. The area of the working electrode is 1 cm² and the area of the counter electrode is 1 mm² in each chamber.

(Manufacturing of Reagent Layer)

The first enzyme of the present example is glucose dehydrogenase, the second enzyme is lactate dehydrogenase, and the third enzyme is cholesterol dehydrogenase.

First, second and third layers formed of carboxymethylcellulose (referred to as ‘CMC layer’ hereinafter) are prepared first. Specifically, an aqueous solution of 0.5% sodium salt of carboxymethylcellulose which is hydrophilic polymer is provided in drops on portions of the substrate where the first, second, and third measurement chambers are to be made. After that, the substrate is dried for ten minutes in a hot air drier heated to 50° C. to prepare the first, second, and third CMC layers on the substrate. The first CMC layer is disposed in the first measurement chamber, the second CMC layer is disposed in the second measurement chamber, and the third CMC layer is disposed in the third measurement chamber. Since the CMC layers are formed, reagent layers which will be described below can be stably formed on the substrate.

Subsequently, the first, second, and third reagent layers are prepared.

A mixed solution of 10 mM NAD, 100 U/ml diaphorase, 100 mM potassium ferricyanide which is an electron transport material, and 300 U/ml glucose dehydrogenase which is the first enzyme is provided in drops on the first CMC layer. After that, the substrate is dried for ten minutes in a hot air drier heated to 50° C., and thus the first reagent layer is formed on the first CMC layer. NAD is an intermediate for transferring electrons from glucose, lactic acid, and cholesterol to potassium ferricyanide. Diaphorase is an enzyme for catalyzing the electron transfer by NAD. Like an electron transport material, NAD and diaphorase are repeatedly utilized for measuring glucose, lactic acid, and cholesterol.

500 U/ml lactate dehydrogenase solution which is the second enzyme is provided in drops on the second CMC layer and dried, and thus the second reagent layer is formed on the second CMC layer.

A mixed solution of TritonX-100 (1.5 wt %), 500 U/ml cholesterol esterase, and 200 U/ml cholesterol dehydrogenase which is the third enzyme is provided in drops on the third CMC layer and dried, and thus the third reagent layer is formed on the third CMC layer.

Cholesterol esterase is an enzyme for decomposing cholesterol ester into cholesterol and fatty acid. A serum cholesterol value utilized as a diagnosis indicator is an amount obtained by summing the amount of blood cholesterol and the amount of cholesterol ester. Therefore, to measure the amount of cholesterol ester and the amount of cholesterol simultaneously, it is necessary first to decompose cholesterol ester contained in a liquid sample into cholesterol and fatty acid using cholesterol esterase.

(Bonding of Substrate, Spacer, and Upper Substrate)

The multicomponent analysis sensor utilized in the present example is manufactured by bonding together of the substrate where the electrodes and the reagent layers are formed, a spacer shaped according to the shapes of the measurement chambers and the channels, and a upper substrate having a liquid sample inlet and an air hole. The size of the measurement chamber in the present example is 12 mm×10 mm, and the size of the channel is 3 mm×3 mm.

### [Method of Measuring Multiple Components]

Hereinafter, a method of measuring glucose, lactic acid and cholesterol from serum utilizing the multicomponent analysis sensor manufactured by the above-described method will be described. In the present example, serum on the market has been utilized as a liquid sample.

A 1 μl drop of serum is injected in the liquid sample inlet, and it is visually confirmed that the serum has reached the first measurement chamber. Then, the serum is allowed to stand for three minutes in the first measurement chamber in order to allow glucose and potassium ferricyanide to react with each other therein. After that, a pulse potential of +0.5 V with respect to the counter electrode is applied to the working electrode. A current flowing between the working electrode and the counter electrode is measured five seconds after the potential is applied. The application of the potential is continued until the current value flowing between the working electrode and the counter electrode becomes constant. A constant current value flowing between the working electrode and the counter electrode means that ferrocyanide ions generated during a reaction with glucose are oxidized back into ferricyanide ions.

After it is confirmed that the current value flowing between the working electrode and the counter electrode has become constant, air is blown into the liquid sample inlet with a syringe to transport the liquid sample existing in the first measurement chamber to the second measurement chamber. It is visually confirmed that the liquid sample has reached the second measurement chamber. Then, the liquid sample is allowed to stand in the second measurement chamber for three minutes in order to allow lactic acid and potassium ferricyanide to react with each other therein. After that, a pulse potential of +0.5 V with respect to the counter electrode is applied to the working electrode. A current flowing between the working electrode and the counter electrode is measured five seconds after the potential is applied. The application of the potential is continued until the current value flowing between the working electrode and the counter electrode becomes constant.

After it is confirmed that the current value flowing between the working electrode and the counter electrode has become constant, air is blown into the liquid sample inlet with a syringe to transport the liquid sample existing in the second measurement chamber to the third measurement chamber. It is visually confirmed that the liquid sample has reached the third measurement chamber. Then, the liquid sample is allowed to stand in the third measurement chamber for three minutes in order to allow cholesterol and potassium ferricyanide to react with each other therein. After that, a pulse potential of +0.5 V with respect to the counter electrode is applied to the working electrode. A current flowing between the working electrode and the counter electrode is measured five seconds after the potential is applied.

As a result, current values depending on the amounts of glucose, lactic acid, and cholesterol in serum are obtained.

Commercially available blood sugar sensors require about 1 μl of blood for measurement, and therefore, requires 3 μl of blood to measure three analytes. On the other hand, the sensor according to the present example can measure three analytes with 1 μl of blood.

In addition, since NAD, diaphorase, and potassium ferricyanide can be repeatedly utilized for measurements of three analytes, the sensor according to the present example requires one-third as much reagent as commercially available sensors for the measurement of three analytes.

The present application is based on Japanese Patent Application No. 2006-273832, filed on Oct. 5, 2006, the entire content of which is expressly incorporated by reference herein.

### INDUSTRIAL APPLICABILITY

A multicomponent analysis sensor and a method of measuring multiple components according to the present invention can measure multiple components accurately and rapidly. In particular, since a liquid sample utilized for measuring one analyte can be re-used for measuring another analyte, multiple components can be measured using a very small amount of liquid sample. Based on the foregoing, the present invention is useful for the clinical test field.

1. A multicomponent analysis sensor for measuring two or more analytes using a redox reaction, the sensor comprising:
a liquid sample inlet through which a liquid sample containing two or more analytes is introduced;
a first measurement chamber;
a second measurement chamber;
a first channel which connects the liquid sample inlet with the first measurement chamber; and
a second channel that connects the first measurement chamber with the second measurement chamber,
wherein each of the first measurement chamber and the second measurement chamber includes at least a working electrode and a counter electrode.

2. A multicomponent analysis sensor for measuring two or more analytes using a redox reaction, the sensor comprising:
a liquid sample inlet through which a liquid sample containing two or more analytes is introduced;
a first measurement chamber;
a second measurement chamber;
a first channel which connects the liquid sample inlet with the first measurement chamber; and
a second channel that connects the first measurement chamber with the second measurement chamber,
wherein each of the first measurement chamber, the second channel and the second measurement chamber includes at least a working electrode and a counter electrode.

3. A multicomponent analysis sensor for measuring two or more analytes using a redox reaction, the sensor comprising:
a liquid sample inlet through which a liquid sample containing two or more analytes is introduced;
a first measurement chamber;
an intermediate chamber;
a second measurement chamber;
a first channel that connects the liquid sample inlet with the first measurement chamber;
a second channel which connects the first measurement chamber with the intermediate chamber; and
a third channel that connects the intermediate chamber with the second measurement chamber,
wherein each of the first measurement chamber, the intermediate chamber, and the second measurement chamber includes at least a working electrode and a counter electrode.

4. The multicomponent analysis sensor according to claim 1, further comprising:
a first enzyme and an electron transport material disposed in one of the first channel and the first measurement chamber; and
a second enzyme disposed in one of the second channel and the second measurement chamber.

5. The multicomponent analysis sensor according to claim 2, further comprising:
a first enzyme and an electron transport material disposed in one of the first channel and the first measurement chamber; and
a second enzyme disposed in the second measurement chamber.

6. The multicomponent analysis sensor according to claim 3, further comprising:
a first enzyme and an electron transport material disposed in one of the first channel and the first measurement chamber; and
a second enzyme disposed in one of the third channel and the second measurement chamber.

7. The multicomponent analysis sensor according to claim 1, wherein one of the working electrode and the counter electrode provided in the first measurement chamber is covered with a polymer.

8. The multicomponent analysis sensor according to claim 2, wherein one of the working electrode and the counter electrode provided in the second channel is covered with a polymer.

9. The multicomponent analysis sensor according to claim 3, wherein one of the working electrode and the counter electrode provided in the intermediate chamber is covered with a polymer.

10. The multicomponent analysis sensor according to claim 1, wherein at least one of the working electrode and the counter electrode provided in the first measurement chamber is a porous material.

11. The multicomponent analysis sensor according to claim 2, wherein at least one of the working electrode and the counter electrode provided in the second channel is a porous material.

12. The multicomponent analysis sensor according to claim 3, wherein at least one of the working electrode and the counter electrode provided in the intermediate chamber is a porous material.

13. A method of measuring two or more analytes in one liquid sample, using an analysis apparatus including the multicomponent analysis sensor according to claim 4, an installation section on which the sensor is mounted, a transport section that transports a liquid sample to a measurement chamber in the sensor, an applying section that applies a potential to an electrode system of the sensor, an instrument section that measures a current flowing through the electrode system of the sensor, and a control section that controls the transport section, the applying section, and the instrument section, the method comprising:
A) supplying the liquid sample to the liquid sample inlet;
B) transporting the liquid sample to the first measurement chamber by the transport section;
C) oxidizing or reducing the electron transport material by allowing a first analyte in the liquid sample, the first enzyme, and the electron transport material to react with one another;
D) applying a potential by the applying section to the working electrode and the counter electrode of the first measurement chamber to which the liquid sample has been transported;
E) measuring the first analyte by measuring, at the instrument section, a current flowing between the working electrode and the counter electrode of the first measurement chamber;
F) changing the electron transport material oxidized or reduced in C) into a reductant or an oxidant reactable with a second analyte in the liquid sample by applying a potential by the applying section to the working electrode and the counter electrode of the first measurement chamber;
G) checking that the electron transport material oxidized or reduced in C) has changed into a reductant or an oxidant reactable with the second analyte by measuring, at the instrument section, a current flowing between the working electrode and the counter electrode of the first measurement chamber;
H) after the checking in G), transporting the liquid sample to the second measurement chamber by the transport section;
I) allowing the second analyte, the second enzyme, and the changed electron transport material to react with one another to oxidize or reduce the electron transport material;
J) applying a potential by the applying section to the working electrode and the counter electrode of the second measurement chamber to which the liquid sample has been transported; and
K) measuring the second analyte by measuring, at the instrument section, a current flowing between the working electrode and the counter electrode of the second measurement chamber.

14. The method according to claim 13, wherein a current value measured at the instrument section in K) is corrected using the current value measured in G), and the second analyte is measured based on the corrected current value.

15. A method of measuring two or more analytes in one liquid sample, using an analysis apparatus including the multicomponent analysis sensor according to claim 5, an installation section on which the sensor is mounted, a transport section that transports a liquid sample to a measurement chamber in the sensor, an applying section that applies a potential to an electrode system of the sensor, an instrument section that measures a current flowing through the electrode system of the sensor, and a control section that controls the transport section, the applying section, and the instrument section, the method comprising:
A) supplying the liquid sample to the liquid sample inlet;
B) transporting the liquid sample to the first measurement chamber by the transport section;
C) oxidizing or reducing the electron transport material by allowing a first analyte in the liquid sample, the first enzyme, and the electron transport material to react with one another;
D) applying a potential by the applying section to the working electrode and the counter electrode of the first measurement chamber to which the liquid sample has been transported;
E) measuring the first analyte by measuring, at the instrument section, a current flowing between the working electrode and the counter electrode of the first measurement chamber;
F) applying a potential by the applying section to the working electrode and the counter electrode formed in the second channel;
G) after measuring the first analyte, transporting by the transport section the liquid sample to the second measurement chamber via the second channel having the working electrode and the counter electrode to which the potential is applied, and changing the electron transport material oxidized or reduced in C) to a reductant or an oxidant reactable with a second analyte in the liquid sample in the second channel;
H) allowing the second analyte, the second enzyme, and the changed electron transport material to react with one another to oxidize or reduce the electron transport material;
I) applying a potential by the applying section to the working electrode and the counter electrode of the second measurement chamber to which the liquid sample has been transported; and
J) measuring the second analyte by measuring, at the instrument section, a current flowing between the working electrode and the counter electrode of the second measurement chamber.

16. The method according to claim 15, wherein a current flowing between the working electrode and the counter electrode of the second channel is measured at the instrument section in G), the current value measured at the instrument section in J) is corrected using the measured current value, and the second analyte is measured based on the corrected current value.

17. A method of measuring two or more analytes in one liquid sample, using an analysis apparatus including the multicomponent analysis sensor according to claim 6, an installation section on which the sensor is mounted, a transport section that transports a liquid sample to a measurement chamber in the sensor, an applying section that applies a potential to an electrode system of the sensor, an instrument section that measures a current flowing through the electrode system of the sensor, and a control section that controls the transport section, the applying section, and the instrument section, the method comprising:
A) supplying the liquid sample to the liquid sample inlet;
B) transporting the liquid sample to the first measurement chamber by the transport section;
C) oxidizing or reducing the electron transport material by allowing a first analyte in the liquid sample; the first enzyme, and the electron transport material to react with one another;
D) applying a potential by the applying section to the working electrode and the counter electrode of the first measurement chamber to which the liquid sample has been transported;
E) measuring the first analyte by measuring, at the instrument section, a current flowing between the working electrode and the counter electrode of the first measurement chamber;
F) after measuring the first analyte, transporting the liquid sample to the intermediate chamber by the transport section;
G) changing the electron transport material oxidized or reduced in C) into a reductant or an oxidant reactable with a second analyte in the liquid sample by applying a potential by the applying section to the working electrode and the counter electrode of the intermediate chamber to which the liquid sample has been transported;
H) checking that the electron transport material oxidized or reduced in C) has been changed into a reductant or an oxidant reactable with the second analyte by measuring, at the instrument section, a current flowing between the working electrode and the counter electrode of the intermediate chamber;
I) after the checking in H), transporting the liquid sample to the second measurement chamber by the transport section;
J) allowing the second analyte, the second enzyme, and the changed electron transport material to react with one another to oxidize or reduce the electron transport material;
K) applying a potential by the applying section to the working electrode and the counter electrode of the second measurement chamber to which the liquid sample has been transported; and
L) measuring the second analyte by measuring, at the instrument section, a current flowing between the working electrode and the counter electrode of the second measurement chamber.

18. The method according to claim 17, wherein a current value measured at the instrument section in L) is corrected using the current value measured in H), and the second analyte is measured based on the corrected current value.
